(19) United States
(12) Patent Application Publication
(10) Pub. No.: US 2009/0132909 A1
(43) Pub. Date: May 21, 2009

(54) INFORMATION PROCESSING APPARATUS AND INFORMATION PROCESSING METHOD

(75) Inventor: Masahiko Kono, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/271,190

(22) Filed: Nov. 14, 2008

(30) Foreign Application Priority Data
Nov. 16, 2007 (JP) 2007-298594

(51) Int. Cl. G06F 17/00; G06F 3/00

(52) U.S. Cl. 715/234; 715/762

(57) ABSTRACT

A method for processing in an information processing apparatus, which is wirelessly connected to a device serving as a Web server, and can control the device using a user interface provided by the device, includes acquiring domain information of the device when the wireless connection is established; acquiring a file required to form the user interface; substituting, by the domain information, a predetermined character string included in a description associated with processing to be executed by the device of a description in a script element included in the file; and displaying the user interface based on the file in which the character string is substituted.

### BACKGROUND OF THE INVENTION

1. Field of the Invention

The present invention relates to an information processing technique which displays a UI (user interface) provided by a device that serves as a Web server on an information processing apparatus via a network, thus allowing the information processing apparatus to remotely control the device.

2. Description of the Related Art

Some devices such as multi-functional peripherals (MFPs) and the like which are compatible to a network are configured to be remotely controlled from a PC by displaying a UI of that device on the PC via a network.

In general, the following two types of configurations are required to implement such function. The first configuration directly displays a touch panel UI of a device on a PC. With this configuration, the user clicks on buttons and the like of the UI displayed on the PC by touching the touch panel, thereby remotely controlling a device.

In the second configuration, a device itself serves as a Web server compatible to HTTP, and calls an HTML file used to form a UI via a browser on the PC, thus allowing to remotely control the device from the PC.

However, the UIs displayed on the PC by the first and second configurations are not optimized to the PC, resulting in low operability.

Under the circumstance, as for the second configuration, in recent years, techniques such as the one called Ajax (Asynchronous JavaScript™+XML) have become available, and they solve such problem by displaying a UI optimized to the PC.

Furthermore, by embedding a program to be executed on the PC in an XML file or HTML file using a script language in this way, a UI having diversity can be displayed, and the processing load on the device side can be reduced. For this reason, the second configuration is effective to implement the aforementioned remote control.

However, in case of the program embedded in an HTML file or the like using a script language, as described above, a security function of a browser of the PC generally inhibits that program from accessing resources of the device serving as an external domain. For this reason, the second configuration cannot display information associated with device resources as a UI on the PC.

By way of exception, such problem can be avoided by executing a JavaScript™ used to acquire resource information of the device after the address of the device serving as an external domain is designated in a script element described in an HTML file or the like. More specifically, when the device is controlled to execute a JavaScript™ to acquire information associated with the resources of the device, the PC reads the execution result to display the information associated with the resources of the device on the PC.

However, in case of a device such as a digital camera or the like which can be wirelessly connected to the PC, the address of the device is dynamically assigned. For this reason, the address of the device serving as an external domain cannot be designated in advance in a script element described in an HTML file or the like.

For this reason, when a device serving as a Web server is wirelessly connected, the resource information of the device cannot be included in a UI to be displayed on the PC via a network.

### SUMMARY OF THE INVENTION

The present invention has been made in consideration of the aforementioned problems.

An information processing apparatus according to the present invention comprises the following arrangement. That is, an information processing apparatus, which is wirelessly connected to a device serving as a Web server, and can control the device using a user interface provided by the device, the apparatus comprising a first acquisition unit configured to acquire domain information of the device when the wireless connection is established; a second acquisition unit configured to acquire a file required to form the user interface; a substitution unit configured to substitute, by the domain information, a predetermined character string included in a description associated with processing to be executed by the device of a description in a script element included in the file; and a display unit configured to display the user interface based on the file in which the character string is substituted by the substitution unit.

According to the present invention, the information processing apparatus which is wirelessly connected to a device serving as a Web server can display a UI including resource information of that device.

Further features and aspects of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing the arrangement of a network system which comprises a PC 102 (information processing apparatus) according to the first embodiment of the present invention, and a digital camera 101 wirelessly connected to the PC 102.

FIG. 2 is a block diagram showing the functional arrangement of the information processing apparatus (PC 102) according to the first embodiment of the present invention.

FIG. 3A is a view showing an example of remote UI data provided by the digital camera 101.

FIG. 3B is a view showing an example of remote UI data provided by the digital camera 101.

FIG. 3C is a view showing an example of remote UI data provided by the digital camera 101.

FIG. 4 is a view showing a display example upon displaying the remote UI data on a monitor 207.

FIG. 5 is a flowchart showing the sequence of processing in the PC 102 until a UI is displayed on the PC 102 based on the remote UI data provided by the digital camera 101.

FIG. 6 is a view showing an example of photoNumber( ).

FIG. 7 is a view showing a display example when contents data generated based on the remote UI data is displayed on the monitor 207.

FIG. 8 is a diagram showing the arrangement of a network system which comprises a PC 802 (information processing apparatus) according to the second embodiment of the present invention.

FIG. 9 is a flowchart showing the sequence of processing in the PC 802 until a UI is displayed on the PC 802.

### DESCRIPTION OF THE EMBODIMENTS

Embodiments of the present invention will now be described in detail in accordance with the accompanying drawings.

### First Embodiment

<1. Arrangement of Network System>

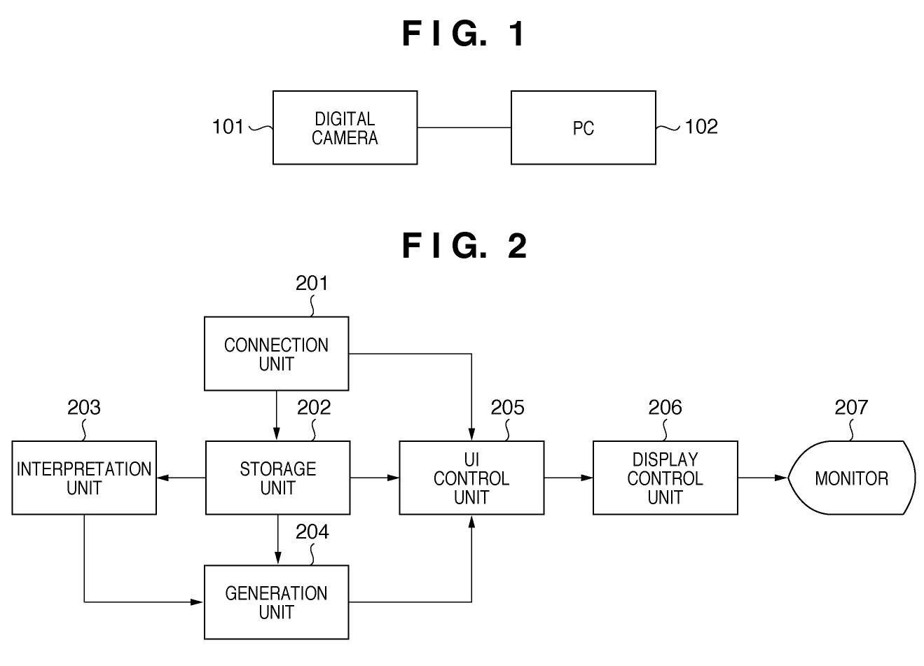

FIG. 1 is a diagram showing the arrangement of a network system which comprises a PC 102 (information processing apparatus) according to the first embodiment of the present invention, and a digital camera 101 wirelessly connected to the PC 102.

In this network system, the digital camera 101 serves as a Web server, and provides remote UI data (data used to generate a UI required to remotely control the digital camera 101 from the PC 102) to the PC 102.

Note that the digital camera 101 executes a JavaScript™ requested from the PC 102 when the PC 102 executes the remote UI data provided to it, and returns an execution result. In this manner, since the digital camera 101 is configured to execute only minimum required processing, it can minimize the memory size and consumption power required to serve as a Web server.

<2. Arrangement of PC 102>

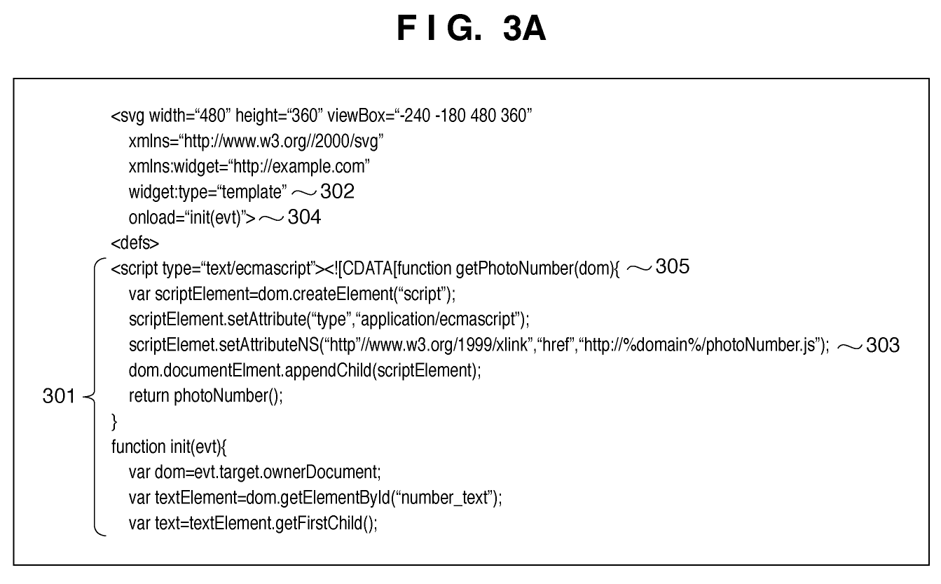

FIG. 2 is a block diagram showing the functional arrangement of the information processing apparatus (PC 102) according to the first embodiment of the present invention.

Referring to FIG. 2, reference numeral 201 denotes a connection unit to which the digital camera 101 is wirelessly connected. Reference numeral 202 denotes a storage unit, which stores remote UI data or the like downloaded from the digital camera 101 wirelessly connected via the connection unit 201.

Reference numeral 203 denotes an interpretation unit which interprets the remote UI data stored in the storage unit 202. Reference numeral 204 denotes a generation unit, which generates contents data to be displayed as a UI based on the interpretation result of the interpretation unit 203.

Reference numeral 205 denotes a UI control unit which executes a JavaScript™ included in the remote UI data stored in the storage unit 202. Reference numeral 206 denotes a display control unit which executes display control by inserting the execution result of the JavaScript™ by the UI control unit 205 in the contents data generated by the generation unit 204 and displaying the contents data on a monitor 207.

<3. Template Held by Digital Camera 101>

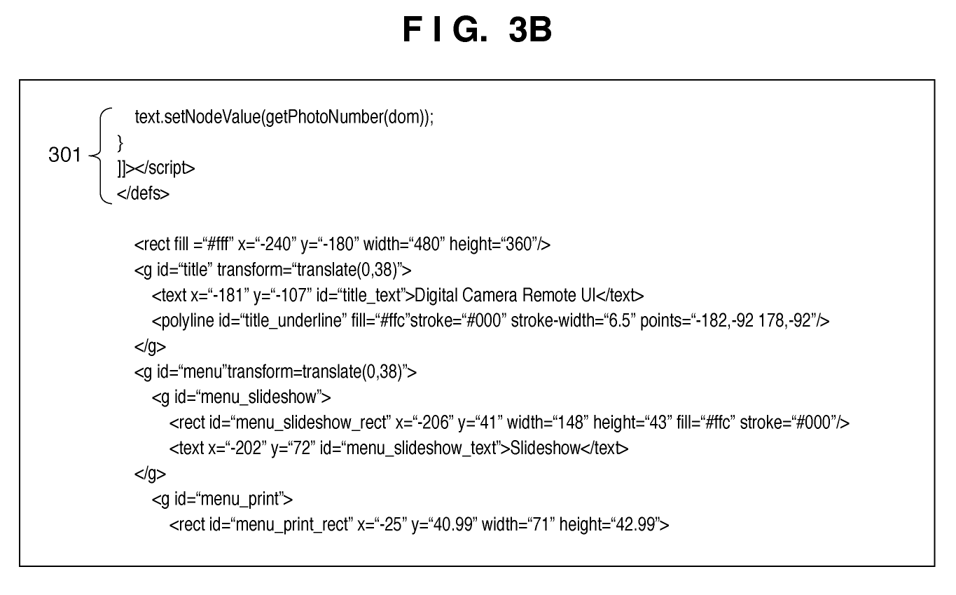

FIGS. 3A to 3C are views showing an example of the remote UI data provided by the digital camera 101. As shown in FIGS. 3A to 3C, the remote UI data according to this embodiment is described in a Scalable Vector Graphics (SVG) (http://www.w3.org/Graphics/SVG/) format.

An SVG file can control to execute a JavaScript™, and a program to be executed is embedded in a <script> element (301) in FIGS. 3A and 3B using a script language.

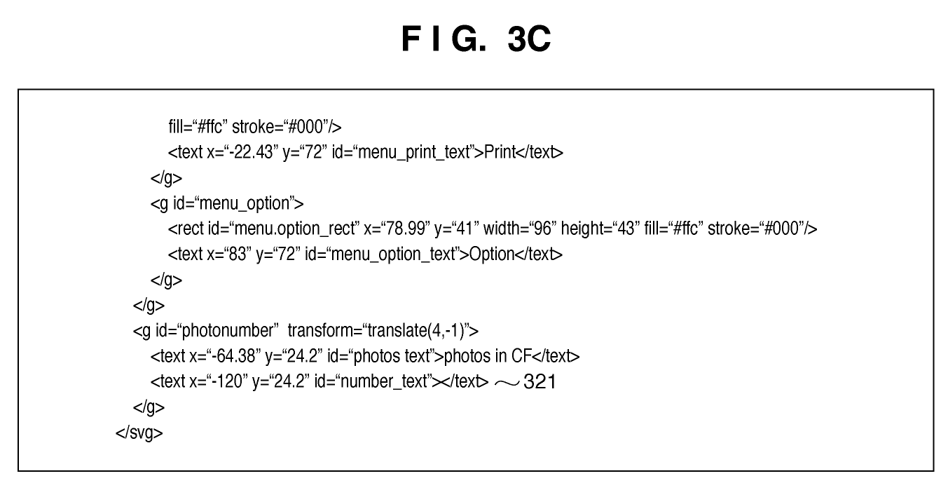

Note that the remote UI data shown in FIGS. 3A to 3C is displayed on the monitor 207, as shown in FIG. 4. In FIG. 3C, a <text> element including id=“number_text” (321) is a description for outputting the number of photographs included in a CF card connected to the digital camera 101. However, in the example of FIG. 3C, the number of photographs is not designated. For this reason, the number of photographs is not displayed on the monitor 207 (401), as shown in FIG. 4.

<4. Sequence of Processing in PC 102>

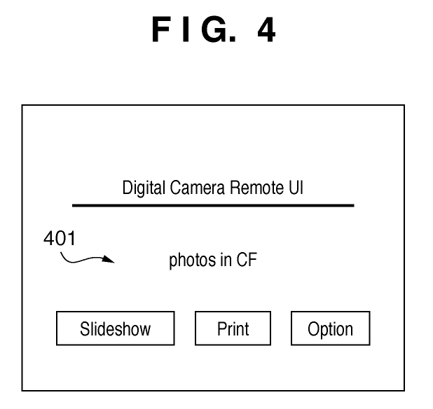

The sequence of processing in the PC 102 until a UI is displayed on the PC 102 based on the remote UI data provided by the digital camera 101 will be described below with reference to the flowchart shown in FIG. 5.

When the digital camera 101 is connected to the connection unit 201 in step S501, the digital camera 101 and PC 102 start a communication.

In step S502, domain information of the connected digital camera 101 is acquired (first acquisition step), and the storage unit 202 stores the acquired domain information. Assume that the domain information of the digital camera 101 is “150.61.145.53” in this embodiment.

In step S503, remote UI data (a file described in the SVG format; file name: ui.svg) is downloaded from the connected digital camera 101 (second acquisition step), and the storage unit 202 stores the downloaded remote UI data.

Note that the downloaded remote UI data may be either raster data such as bitmap data or HTML data which can operate intact. Hence, the interpretation unit 203 interprets the remote UI data stored in the storage unit 202.

It is determined in step S504 based on the interpretation result of the interpretation unit 203 if the remote UI data is a template. To attain this determination, the interpretation unit 203 checks

(A) if the remote UI data is a file described in the SVG format,

(B) if the remote UI data includes a type attribute of a widget name space, and

(C) if an attribute value of that attribute is “template”.

If all of (A), (B), and (C) are satisfied, the interpretation unit 203 determines that this remote UI data is a template. Since the remote UI data shown in FIGS. 3A to 3C is a file described in the SVG format, and the value of a widget:type attribute in an <svg> element is “template” (302 in FIG. 3A), that data is determined as a template.

As a result of determination in step S504, if it is determined that the remote UI data is a template, the process advances to step S505; otherwise, the processing ends.

In step S505, the generation unit 204 sets the domain information of the digital camera 101 as that of a device to be remotely controlled by the PC 102 via a UI.

Furthermore, in step S506 the generation unit 204 searches to see if the script element in the remote UI data includes a predetermined character string “%domain%”. The generation unit 204 substitutes the found character string by the domain information stored in step S502, thus generating contents data.

In the example of FIG. 3A, getPhotoNumber( ) in the script element includes “%domain%” (303). For this reason, this character string is substituted by the domain information “150.61.145.53” (URI) of the digital camera 101, thereby generating contents data.

In step S507, upon completion of reading of the generated contents data, the UI control unit 205 which launches the contents data as a UI generates a load event, and calls a load event handler. In the example of FIG. 3A, since an init( ) function (304) of a script is registered as the load event handler in the form of onload=“init(evt)” in an <svg> element, the unit 205 calls this function. The init( ) function substitutes the contents of the <text> element including id=“number_text” by the number of photographs included in a CF card of the digital camera. For this purpose, a getPhotoNumber( ) function (305) is called in step S508.

In step S509, the getPhotoNumber function generates a script element first. The function registers “http://150.61.145.53/photoNumber.js” as a script to be registered in the script element, and adds it to the contents data.

In step S510, the connection unit 201 requests the digital camera 101 to execute photoNumber.js.

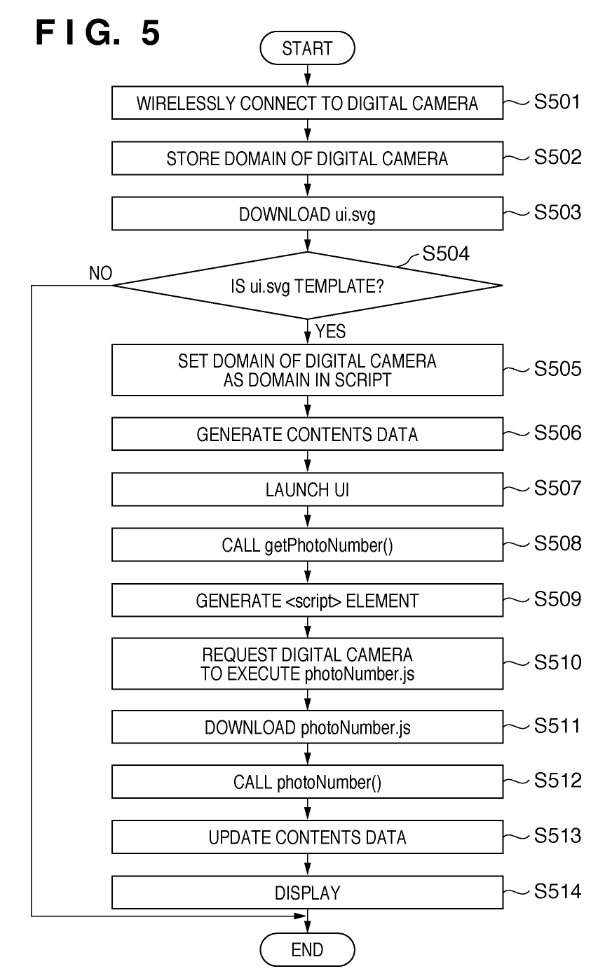

In response to the request from the connection unit 201, the digital camera 101 acquires the number of photographs included in a CF card at that time, and generates a function photoNumber( ). Assume that the digital camera 101 stores 200 photographs at that time in this embodiment. For this reason, photoNumber( ) is described, as shown in FIG. 6.

After the digital camera 101 generates photoNumber.js, the connection unit 201 downloads photoNumber.js in step S511.

In step S512, the UI control unit 205 calls photoNumber( ) and obtains “200” as a return value. In step S513, the unit 205 updates the contents data based on the obtained value.

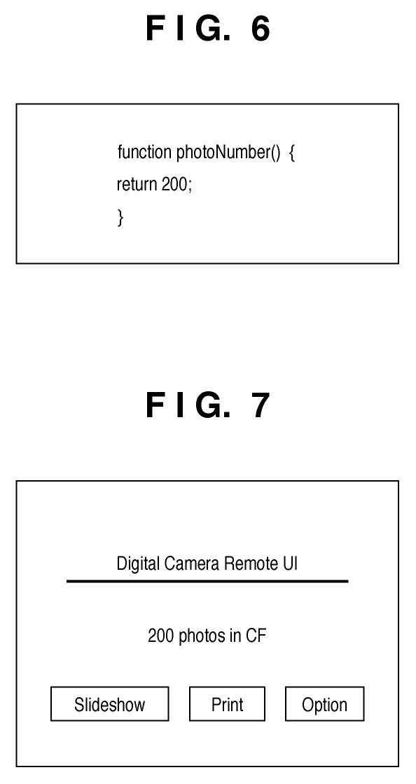

Upon completion of the event processing, the display control unit 206 displays a UI on the monitor 207 in step S514. As a result, a display on the monitor 207 is, as shown in FIG. 7. That is, upon displaying the remote UI data (FIG. 4), the number of photographs as the resource information of the digital camera is not displayed. However, upon displaying the contents data generated based on the remote UI data, the number of photographs is displayed.

As described above, according to this embodiment, upon connecting to a digital camera, the domain information of the digital camera is acquired, and a predetermined character string in the JavaScript™ included in the downloaded remote UI data is substituted by the domain information.

As a result, even when the address of the digital camera is dynamically assigned, the digital camera is controlled to execute the JavaScript™ to access the resource information. Then, the UI including the resource information of the digital camera can be displayed on the PC.

### Second Embodiment

In the first embodiment, remote UI data is stored in the digital camera, and the PC downloads the remote UI data from the digital camera. However, the present invention is not limited to this.

Remote UI data may be independently stored in a template server, and may be downloaded from the template server.

<1. Arrangement of Network System>

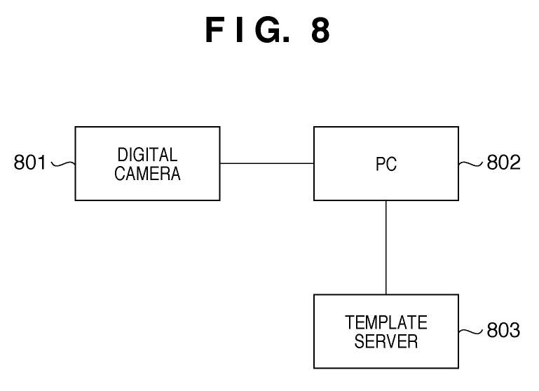

FIG. 8 is a diagram showing the arrangement of a network system which comprises a PC 802 (information processing apparatus) according to the second embodiment of the present invention.

Referring to FIG. 8, reference numeral 801 denotes a digital camera, which is connected to the PC 802 according to this embodiment. Reference numeral 803 denotes a template server, which stores remote UI data.

Assume that the digital camera 801 and PC 802 are connected via a wireless LAN, and the PC 802 and template server 803 are connected via a WAN. Also, assume that the digital camera 801 and template server 803 cannot directly communicate with each other.

<2. Sequence of Processing in PC 802>

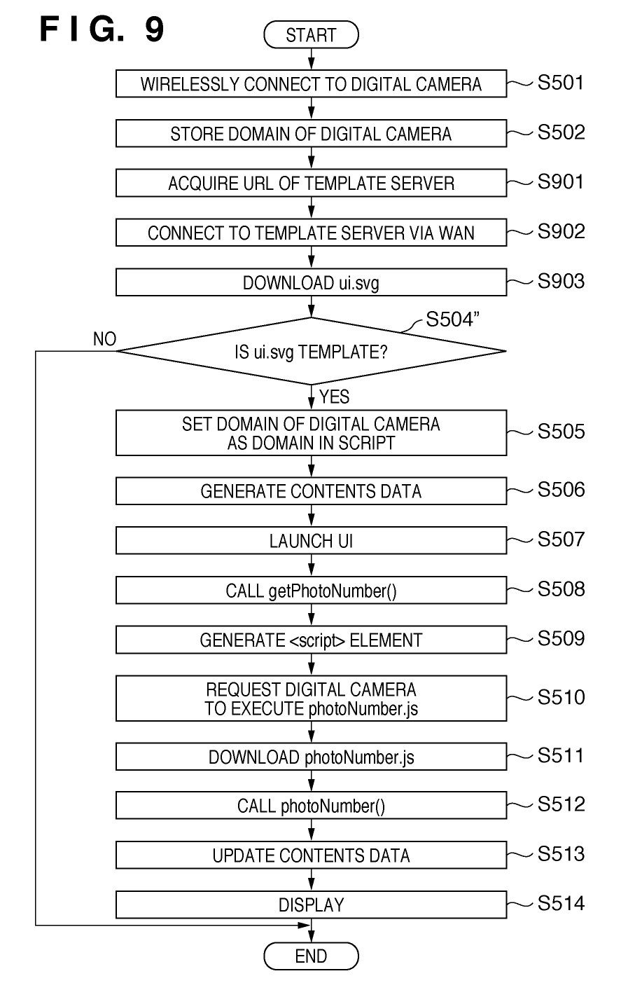

The sequence of processing in the PC 802 until a UI is displayed on the PC 802 will be described below with reference to the flowchart shown in FIG. 9. Note that the following description will be given for differences from the sequence of the processing in the PC 102 of the first embodiment (FIG. 5) (the same step numbers denote steps common to FIG. 5).

The steps until the digital camera 801 is wirelessly connected to the PC 802 and the PC 802 acquires domain information of the digital camera (steps S501 and S502) are the same as those in the first embodiment.

In step S901, the connection unit 201 acquires a URL of the template server 803 from the digital camera 801, and saves it in the storage unit 202. Note that the URL of the template server 803 in this embodiment is “http://www.example.com/ui.svg”.

In step S902, the connection unit 201 establishes a connection to the template server 803 via the WAN based on the URL and starts a communication.

In step S903, the connection unit 201 downloads remote UI data (file name: ui.svg) from the template server 803, and stores it in the storage unit 202.

The subsequent steps (steps S504 to S514) are the same as those in the first embodiment.

As can be seen from the above description, in this embodiment, upon connecting to the digital camera, the domain information of the digital camera is acquired, and the URL of a storage source of remote UI data is acquired. When the remote UI data is downloaded from the storage source, a predetermined character string in a JavaScript™ included in the downloaded remote UI data is substituted by the acquired domain information.

As a result, even when the address of the digital camera is dynamically assigned, the digital camera is controlled to execute the JavaScript™ to access the resource information. Then, the UI including the resource information of the digital camera can be displayed on the PC.

### Other Embodiments

Note that the present invention may be applied to either a system constituted by a plurality of devices (e.g., a host computer, interface device, reader, printer, and the like), or an apparatus consisting of a single device (e.g., a copying machine, facsimile apparatus, or the like).

The objects of the present invention are also achieved by supplying a storage medium (i.e., a computer-executable storage medium), which records a program code of software that implements the functions of the aforementioned embodiments to the system or apparatus. In this case, the functions are implemented when a computer (or a CPU or MPU) of the system or apparatus reads out and executes the program code stored in the storage medium. Note that the storage medium that stores the program code constitutes the present invention in such case.

As the storage medium for supplying the program code, for example, a floppy disk, hard disk, optical disk, magneto-optical disk, CD-ROM, CD-R, magnetic tape, nonvolatile memory card, ROM, and the like may be used.

The present invention is not limited to the case in which the functions of the aforementioned embodiments are implemented when the computer executes the readout program code. For example, the present invention also includes a case in which an OS (operating system) or the like running on a computer may execute some or all of actual processes based on an instruction of the program code to implement the functions of the aforementioned embodiments.

Furthermore, the present invention also includes a case in which the functions of the aforementioned embodiments are implemented after the program code read out from the storage medium is written in a memory equipped on a function expansion board or unit, which is inserted in or connected to the computer. That is, the present invention includes a case in which after the program code is written in the memory, a CPU or the like equipped on the function expansion board or unit executes some or all of actual processes based on an instruction of the program code, so as to implement the functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-298594 filed on Nov. 16, 2007, which is hereby incorporated by reference herein in its entirety.

What is claimed is:

1. An information processing apparatus, which is wirelessly connected to a device serving as a Web server, and can control the device using a user interface provided by the device, comprising:
a first acquisition unit configured to acquire domain information of the device when the wireless connection is established;
a second acquisition unit configured to acquire a file required to form the user interface;
a substitution unit configured to substitute, by the domain information, a predetermined character string included in a description associated with processing to be executed by the device of a description in a script element included in the file; and
a display unit configured to display the user interface based on the file in which the character string is substituted by the substitution unit.

2. The apparatus according to claim 1, wherein the display unit receives a result of the processing executed by the device based on the description associated with the processing to be executed by the device, and displays the result on the user interface.

3. The apparatus according to claim 1, wherein the description in the script element is described using JavaScript™.

4. The apparatus according to claim 1, wherein the file is a Scalable Vector Graphics file.

5. A method for processing in an information processing apparatus, which is wirelessly connected to a device serving as a server, and can control the device using a user interface provided by the device, the method comprising:
acquiring domain information of the device when the wireless connection is established;
acquiring a file required to form the user interface;
substituting, by the domain information, a predetermined character string included in a description associated with processing to be executed by the device of a description in a script element included in the file; and
displaying the user interface based on the file in which the character string is substituted.

6. A computer-readable storage medium encoded with a program for making a computer to execute a method for processing in an information processing apparatus, which is wirelessly connected to a device serving as a Web server, and can control the device using a user interface provided by the device, the method comprising:
acquiring domain information of the device when the wireless connection is established;
acquiring a file required to form the user interface;
substituting, by the domain information, a predetermined character string included in a description associated with processing to be executed by the device of a description in a script element included in the file; and
displaying the user interface based on the file in which the character string is substituted.
